(19) United States
(12) Patent Application Publication
(10) Pub. No.: US 2016/0177600 A1
(43) Pub. Date: Jun. 23, 2016

(54) ADJUSTMENT DEVICE FOR A LOCK OF A FRONT HOOD OF A MOTOR VEHICLE AND ASSOCIATED MOTOR VEHICLE

(71) Applicant: AUDI AG, 85045 Ingolstadt (DE)

(72) Inventors: PETER KUGLER, Donauwörth (DE); WOLFGANG DORFNER, Buxheim (DE); HARALD STERNECKER, Beilngries (DE); BERNHARD-KONRAD PFALLER, Denkendorf (DE); MANFRED SCHINDLER, Markt Schwaben (DE)

(73) Assignee: AUDI AG, 85045 Ingolstadt (DE)

(21) Appl. No.: 14/908,907

(22) PCT Filed: Jul. 19, 2014
(86) PCT No.: PCT/EP2014/001974

§ 371 Date: Jan. 29, 2016

(30) Foreign Application Priority Data
Aug. 1, 2013 (DE) 10 2013 012 832.3

(51) Int. Cl. E05B 77/08; E05C 19/02; B62D 25/12; E05B 83/18; E05B 83/24; E05C 1/08; E05B 77/06

(52) U.S. Cl. CPC E05B 77/08; E05C 1/085; E05C 19/028; E05B 77/06; E05B 83/18; E05B 83/243; B62D 25/12

(57) ABSTRACT

An adjustment device for a lock of a front hood of a motor vehicle, with the front hood being movable from a normal position to an elevated position, includes a guide and a carriage which is coupled with the lock and movable along the guide. At least one wedge is configured to clamp the carriage with the guide in a clamping position. An actuating mechanism is provided to allow movement of the carriage from the clamping position to an unclamped position by displacing the at least one wedge.

The invention relates to an adjustment device for a lock of a front hood of a motor vehicle, which front hood is movable from a normal position to an elevated position.

To reduce risk of injury to pedestrians in the event of a collision with a motor vehicle, front hoods have been developed that can be actively lifted after detection of an impact so as to be able to absorb part of the impact energy through deformation of the front hood. Such active hoods are normally shifted vertically upwards and in addition towards the rear. By lifting the front hood, a deformation space is formed between the hood and the engine compartment. The elevated position of the front hood is also referred to as pedestrian protection position; optionally, provision may also be made for a so-called type damage position in which the front hood can also be brought to an elevated and rearwardly offset position.

DE 10 2010 029 719 A1 discloses a hinge for a front hood of a motor vehicle, which front hood is adjustable by an actuator from a closed position to an elevated pedestrian protection position.

DE 10 2007 056 691 A1 discloses a pedestrian protection device for a motor vehicle, wherein the lock is movably mounted on the body side to a guide and executes during an adjustment from the normal position to the elevated position a combined movement, which consists of a displacement along the guide and a pivoting motion. In this way, the lock attached to the body is conjointly moved as the front hood moves. No actuator is provided in the area of the lock; the relative movement of the lock is achieved solely by the kinematics of the support of the front hood.

The invention is based on the object to provide an adjustment device which allows easy displacement of the lock, when the front hood is moved from a normal position to an elevated position.

To achieve this object, an adjustment device of the afore-mentioned type is provided in accordance with the invention with a carriage which is movable along a guide and coupled with the lock and which is jammed in a clamping position with the guide by at least one wedge and is movable by an actuator for movement of the at least one wedge to an unclamped position in which the carriage can be displaced.

The adjustment device according to the invention allows a locking of the carriage which is movable along a guide. This locked state is established, when the front hood of the motor vehicle assumes the normal position. In this state, the front hood is closed and coupled at its front end to the body by a lock. When the front hood has been moved in the event of an imminent or detected collision with another road user, e.g. a pedestrian, from the normal position to the elevated position, the carriage is also clamped with the guide, i.e. the lock assumes a locked position in which an undesired shift is prevented. As the front hood moves from the normal position to the elevated position, the pedestrian protection position or the type damage position, the carriage thus coupled to the lock is shifted along the guide essentially vertically, so that the lock tracks the movement of the front hood.

In the clamping position, the wedge is situated between the inner side of the guide and the outer side of the carriage. The shape of the wedge causes a self-locking effect, i.e. there is no possibility of a relative movement in the clamping position between the guide and the carriage, so that the carriage and the lock coupled thereto are captivated in the desired position. Even increasing the force would not lead to a relative movement because of the self-locking effect.

Provision may be made in the adjustment device according to the invention that the at least one wedge is shiftable from the clamping position by a slide which is displaceable by the actuator. The displacement of the slide releases the clamping action, so that the carriage and the attached lock are movable along the guide. This has the advantage that the drive of the actuator requires merely comparatively little force to move the slide so that also the at least one wedge is released to thereby render the self-locking effect ineffective. In contrast thereto, an actuator provided to release the carriage and the lock coupled thereto, would require a much larger force, which, in turn, requires the provision of a more powerful actuator. Conversely, in accordance with the invention, an actuator can be used, which has comparatively small power, as it only assumes the task to move a slide over a comparatively small distance.

A particularly reliable operation of the adjustment device according to the invention is realized, when being provided with a first wedge which blocks in the clamping position a movement along a first direction, and with a second wedge which blocks in the clamping position a movement along a second, opposite direction. Using the two wedges, movements along the guide can be inhibited or cleared in both directions.

The adjustment device according to the invention can be configured such that the at least one slide is biased by a spring having a spring force by which the slide or the wedge being displaced by the slide can be moved to the, clamping position. Accordingly, the wedge assumes the clamping position whenever the actuator is idle. In this state, when the actuator is switched off, the spring force holds the slide and the wedge in the clamping position. Only when the actuator is switched on is the slide being moved in opposition to the spring force so as to release the wedges from the clamping position.

In the adjustment device according to the invention, it is preferred to provide it with two wedges arranged on opposite sides of the guide. In this manner, tilting of the slide or the carriage is precluded as a result of a contact with the wedges on two opposite sides.

In order to reduce the space requirement, provision may be made for the slide of the adjustment device according to the invention to have a recess extending in transverse direction for engagement of a radially inwardly extending projection of the or a wedge. The projection of the wedge is mounted in the recess of the slide at a certain tolerance so that small angle or position tolerances can be compensated. Conversely, the wedges are reliably guided by the slide in this manner, so that the desired clamping action can be reliably realized.

According to a further configuration of the invention, provision may be made for the carriage to have a recess for the actuator or a control element coupled to the actuator. In this configuration, the actuator can be arranged in the center of the carriage and operate the wedge(s) or the slide through movement in one direction so as to release the self-locking effect. By a change in direction of the actuator, the opposite slide can be operated to allow movement in the opposite direction.

In the adjustment device according to the invention, the actuator may include an electric or pneumatic or hydraulic drive.

It is also within the scope of the invention that the carriage has at least one recess which extends in longitudinal direction of the guide and is traversed by the slide. When the slide traverses the recess of the carriage, the adjustment device can be built particularly compact.

The invention relates in addition to a motor vehicle, including a front hood which can be moved from a normal position to an elevated position, and which has a lock that can be adjusted by an adjustment device.

The motor vehicle according to the invention is characterized in that it includes an adjustment device of the type described.

Further advantages and details of an exemplary embodiment according to the invention become readily apparent hereinafter with reference to the drawings. The drawings are schematic views and show:

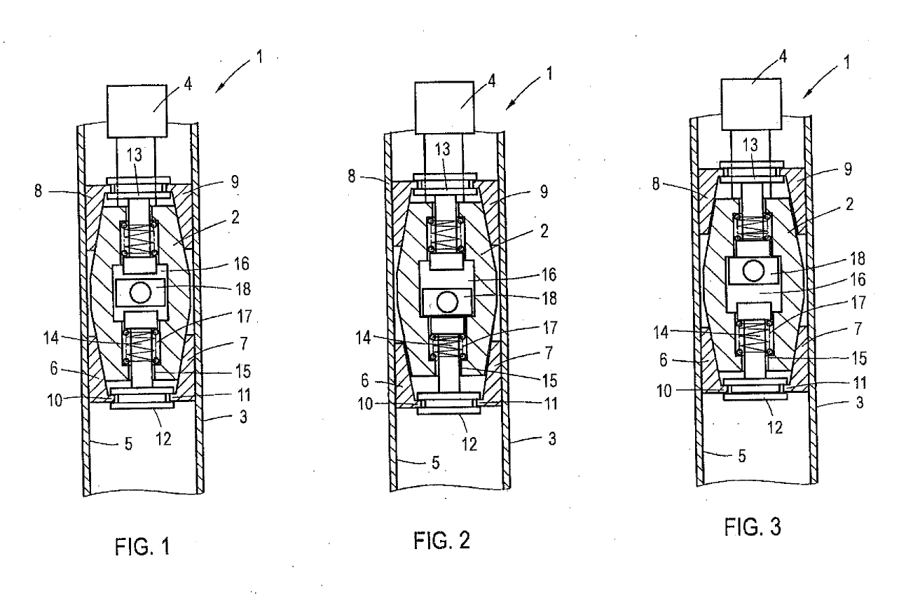

FIG. 1 an adjustment device according to the invention in a first position;

FIG. 2 the adjustment device of FIG. 1 in a second position; and

FIG. 3 the adjustment device of FIG. 1 in a third position.

The adjustment device 1, shown in FIG. 1 by way of a sectional view, includes a carriage 2 which is movable along a guide 3. The carriage 2 is coupled with a lock 4, shown only schematically in FIG. 1, and movable vertically along the guide 3, when the carriage 2 is displaced.

The lock 4 is provided for locking a front hood of a motor vehicle, which front hood is movable from a normal position to an elevated position, when an impact with another road user, especially a pedestrian, is imminent or has been detected. The front hood is then lifted at its rear end and at the same time moved towards the vehicle rear end. The adjustment device 1 enables in this situation to suit the position of the lock 4 to the shifted front hood.

In FIG. 1 it can be seen that four wedges 6, 7, 8, 9 are arranged between the carriage 2 and an inner side 5 of the guide 3. The wedges 6, 7, 8, 9 are arranged such that one wedge, face rests against the inside 5 of the guide 3, another wedge face rests against the outer side of the carriage 2. The carriage 2 thus has four outer surfaces conforming to the size and the wedge angle of the wedges 6-9.

The wedges 6, 7 are arranged on opposite inner sides 5 of the guide 3, as are the wedges 8, 9.

In the position shown in FIG. 1, the carriage 2 and thus the lock 4 are wedged in the guide 3. The wedges 6-9 have each an inwardly extending projection 10 which engages in a recess 11 of a slide 12. In the illustrated exemplary embodiment, the slide 12 has two opposite recesses 11. Of course, also other configurations are conceivable which involve merely a single recess or more than two recesses. The carriage 2 is constructed symmetrically and has on its opposite side a further slide 13 with a recess to hold projections of the wedges 8, 9. The slides 12, 13 have a portion 14 which extends in longitudinal direction and which traverses a recess 15 of the carriage 2 and feeds into a central recess 16 of the carriage 2. The portion 14, extending in the longitudinal direction of the slide 12, is acted upon by a spring 17, shown only schematically, which is designed as a compression spring and supported by the carriage 12, on one hand, and the slide 12, on the other hand.

In the state shown in FIG. 1, the slide 12 is pressed under the influence of the energy stored in the spring 17 against the carriage 2, until the wedges 6, 7 bear upon the corresponding outer surfaces of the carriage 2, thereby realizing a self-locking effect.

The slide 13 arranged on the opposite side has also a respective spring, so that the slide 13 is moved in opposite direction towards the carriage 2, until the wedges 8, 9 prevent further displacement of the slide 13. In this position, a self-locking effect is established so that the carriage 2 and the lock 4 coupled thereto are fixed in place.

A control element 18 can be seen in the central recess 16 and is coupled to an actuator. In the illustrated exemplary embodiment, the actuator is configured as an electric motor; a further transmitting element (not shown), e.g. a toothed rack or a threaded spindle, converts the rotational motion of the electric motor to a linear motion, so that the control element is movable in the longitudinal direction of the guide 3.

FIG. 2 shows the state after the control element 18 has been moved downwards from its neutral position shown in FIG. 1, i.e. towards the slide 12. When the control element 18 touches the slide 12, the latter is shifted along the guide 3 and moves conjointly the coupled wedges 6, 7 so as to move them away from the carriage 2. The control element 18 initially overcomes the forced exerted by the spring 17 and moves the slide 12 subsequently away from the carriage 2. In this state, the clamping action is released so that the carriage 2 can be moved downwards. In this state, the upper wedges 8, 9 in FIG. 2 follow so that the clamping action is also released on this side of the carriage. In the unclamped state, the carriage 2 can be moved as far as desired along the guide 3, as the wedges 6, 7 are released and lead, while the wedges 8, 9 are released and trail. By a movement of the carriage 2, the coupled lock 4 can be moved virtually along the guide as much as desired.

To execute a movement in the opposite direction, the control element 18 is moved in the opposite direction. Polarity of the actuator coupled with the control element 18 is reversed for this purpose, so that the control element 18—as shown in FIG. 3—is moved in the opposite direction, upwards in FIG. 3. In this state, the control element 18 overcomes the spring force generated by the spring of the slide 13 (compressive force) to urge the slide 13 and the wedges 8, 9 downwards against the carriage 2. When the control element 18 bears upon the slide 13, the wedges 8, 9 are moved from the clamping position, in which they rest on the inner side 5 of the guide 3, on the one hand, and on the outer sides of the carriage 2, on the other hand, to a released position. In this state, the locking action is no longer effective and the clamping action of the carriage is released; the carriage 2 can now be moved upwards as much as desired. The wedges 6, 7 arranged on the other end of the carriage 2 follow and release the clamping action spontaneously.

The actuator for the operation of the control element 18 requires only little power because it operates only one of the slides 12, 13 at one time; only a small force is required for this purpose. On the other hand, the wedges 6-9 generate a great clamping force, which firmly hold the carriage 2 in any desired position. Accordingly, the adjustment device 1, shown in FIGS. 1-3, enables both a reduction of the force to be applied and the use of an actuator with little power.

What is claimed is:

1-10. (canceled)

11. An adjustment device for a lock of a front hood of a motor vehicle, which front hood is movable from a normal position to an elevated position, said adjustment device comprising:
a guide;
a carriage coupled with the lock and movable along the guide;
at least one wedge configured to clamp the carriage with the guide in a clamping position; and
an actuating mechanism constructed to allow movement of the carriage from the clamping position to an unclamped position by displacing the at least one wedge.

12. The adjustment device of claim 11, wherein the actuating mechanism includes an actuator and a slide which is shiftable by the actuator to move the at least one wedge away from the clamping position.

13. The adjustment device of claim 11, wherein the at least one wedge blocks in the clamping position a movement along a first direction, and further comprising a further wedge which blocks in the clamping position a movement along a second, opposite direction.

14. The adjustment device of claim 12, wherein the actuating mechanism includes a spring having a spring force which acts on the slide so that the slide and the wedge are urged to seek the clamping position.

15. The adjustment device of claim 11, further comprising a further wedge, said two wedges being arranged on opposite sides of the guide.

16. The adjustment device of claim 12, wherein the slide has a recess extending in a transverse direction for engagement of a radially inwardly extending projection the wedge.

17. The adjustment device of claim 11, wherein the carriage has a recess for receiving the actuator or a control element coupled to the actuator.

18. The adjustment device of claim 12, wherein the actuator comprises an electric or pneumatic or hydraulic drive.

19. The adjustment device of claim 12, wherein the carriage has at least one recess which extends in longitudinal direction and is traversed by the slide.

20. A motor vehicle, comprising:
a front hood which is movable from a normal position to an elevated position and has a lock; and
an adjustment device configured for adjustment of the lock, said adjustment device including a guide, a carriage coupled with the lock and movable along the guide, at least one wedge configured to clamp the carriage with the guide in a clamping position, and an actuating mechanism constructed to allow movement of the carriage from the clamping position to an unclamped position by displacing the at least one wedge.

21. The motor vehicle of claim 20, wherein the actuating mechanism includes an actuator and a slide which is shiftable by the actuator to move the at least one wedge away from the clamping position.

22. The motor vehicle of claim 20, wherein the at least one wedge blocks in the clamping position a movement along a first direction, said adjustment device including a further wedge which blocks in the clamping position a movement along a second, opposite direction.

23. The motor vehicle of claim 21, wherein the actuating mechanism includes a spring having a spring force which acts on the slide so that the slide and the wedge are urged to seek the clamping position.

24. The motor vehicle of claim 20, wherein the adjustment device includes a further wedge, said two wedges being arranged on opposite sides of the guide.

25. The motor vehicle of claim 21, wherein the slide has a recess extending in a transverse direction for engagement of a radially inwardly extending projection the wedge.

26. The motor vehicle of claim 20, wherein the carriage has a recess for receiving the actuator or a control element coupled to the actuator.

27. The motor vehicle of claim 21, wherein the actuator comprises an electric or pneumatic or hydraulic drive.

28. The motor vehicle- of claim 21, wherein the carriage has at least one recess which extends in longitudinal direction and is traversed by the slide.
